(19) United States
(12) Patent Application Publication
(10) Pub. No.: US 2013/0285366 A1
(43) Pub. Date: Oct. 31, 2013

(54) NON-CROSSLINKED SHRINKABLE CASING MEMBER FOR FORMING A CONNECTION BETWEEN TUBULAR SECTIONS AND METHOD OF FORMING SAID CONNECTION BY INDUCTION FUSION

(71) Applicants: Dilip Kumar Tailor, Mississauga (CA); Ronald J. Dunn, Oakville (CA); Pascal Laferriere, Toronto (CA); Aaron Klejman, Toronto (CA)

(72) Inventors: Dilip Kumar Tailor, Mississauga (CA); Ronald J. Dunn, Oakville (CA); Pascal Laferriere, Toronto (CA); Aaron Klejman, Toronto (CA)

(73) Assignee: SHAWCOR LTD., Toronto, ON (CA)

(21) Appl. No.: 13/880,582

(22) PCT Filed: Oct. 21, 2011
(86) PCT No.: PCT/CA2011/050664

§ 371 Date: Jun. 27, 2013

Related U.S. Application Data
(60) Provisional application No. 61/405,940, filed on Oct. 22, 2010.

(51) Int. Cl. B29D 23/00; F16L 47/22

(52) U.S. Cl. CPC B29D 23/005; F16L 47/22
USPC 285/21.2; 156/158

(57) ABSTRACT

A method for forming a connection between two tubular sections having a polymeric outer surface jacket, using induction heat to fusion bond a casing of similar, non-crosslinked polymer to the outer surface of the tubular sections. Casing with a configuration capable of such fusion bonding.

### CROSS REFERENCE TO RELATED APPLICATION

This application claims the benefit of and priority to U.S. Provisional Application No. 61/405,940 filed Oct. 22, 2010 under the title NON-CROSSLINKED SHRINKABLE CASING MEMBER FOR FORMING A CONNECTION BETWEEN TUBULAR SECTIONS AND METHOD OF FORMING SAID CONNECTION BY INDUCTION FUSION. The content of the above patent application is hereby expressly incorporated by reference into the detailed description hereof.

### FIELD OF THE INVENTION

The present invention relates to a method for forming a connection between two tubular sections having a polymeric outer surface jacket, using induction heat to fusion bond a casing of similar, non-crosslinked polymer to the outer surface of the tubular sections. The invention also relates to casing with a configuration capable of such fusion bonding.

### BACKGROUND OF THE INVENTION

Usually, preinsulated pipe for district heating pipeline construction is an inner, metal pipe, insulated with suitable foam, which is coated with an external jacket of certain polymer coating. The ends of the pipe are left bare to allow the exposed ends to be welded together at a pipe joint. This pipe joint is then covered and protected. There are several different casing types used in the art to cover and protect pipe joints. For example, the casing may be in the form of a heat shrinkable casing applied around the welded pipe joint. The casing is fitted to the pipe joint, then heat shrunk down onto the joint. The casing is longitudinally wide enough to overlap the mainline polymer coating of the two sections of pipe. The overlapping area has a suitable adhesive between the casing and the jacket to provide a seal. An example of one such casing is shown in U.S. Pat. No. 4,521,470, incorporated herein by reference.

Such casings can be pre-formed cylindrical casings, which are (in pre-shrunk state) of a slightly larger diameter than the coated pipe. In the case of such casing, the casing is slid around one of the pipes before the pipe joint is welded, then positioned around the pipe joint after the welding of the two pipes. Such casing may also be made from flexible sheets or film, which is positioned around the circumference of the pipe joint after the pipe joint is welded. In this case, the flexible sheet or film typically has two opposed, overlapping edges, lying longitudinally across the pipe joint; these overlapping edges are bonded or fused together before the casing is heat shrunk.

In many cases, casing are bonded to the polymeric outer surface jacket of the pipe using an adhesive, which is either applied to the outer surface jacket or which is pre-existing as a separate, inner layer of the casing. Thus, a known method of installing a pipeline in the field includes (1) welding together the exposed ends of a pipe at a pipe joint; (2) applying a casing in the form of a flexible sheet having a first, adhesive layer and a second, polymeric layer, so that the flexible sheet overlaps the outer surface jacket of the two pipes being connected; (3) bonding the overlapping edges of the flexible sheet to form a casing surrounding the pipe joint, so that the first, adhesive layer becomes an inner layer; (4) heat shrinking the casing around the pipe joint, while simultaneously heating the inner adhesive layer of the casing to bond the casing to the polymeric outer surface jackets of the two pipes on either side of the pipe joint. Often, such a method also requires pre-heating of the polymeric outer surface jacket of the two pipe sections in order to optimize the bond. Often, after step (4), since an air gap remains between the middle area of the casing and the exposed, welded pipe joint, a suitable foam insulation is added by pouring or injecting a foam precursor, either using pre-existing injection openings in the casing, or by making a small hole or set of holes(for example, a pair of drilled 5 mm holes) in the casing and filling it with a suitable foam precursor.

In these known methods, typically, a cross-linked polymer is used for the polymeric layer of the casing, since this provides hoop stress, post-shrinking, that is stronger and more stable over time, as compared to its non-cross linked counterpart, resulting in a stronger bonding of the two surfaces. A cross-linked polymer can typically be subjected to a greater of stretch and resultant shrinking. A cross-linked polymer thus provides a stronger, longer lasting bond between the casing and the polymeric outer surface jacket of the pipes, and maintains and sustains the hoop stress around the pipe jacket for the life expectancy of the joint, thereby maintaining the seal at the overlapped bonded overlaps. Unfortunately, such a cross-linked polymer is much more expensive to manufacture than its non-cross linked counterpart.

An alternative method for casing a pipe joint in the field is described, for example, in U.S. Pat. No. 4,629,216 published Dec. 16, 1986, incorporated herein by reference. Here, non-shrink, non cross-linked casings are used. These casings are bonded to the polymeric outer surface of preinsulated pipes using electric heating elements, within the casing, to heat and melt the casing to the pipe. These have provided connections which may not be considered adequate in all circumstances, particularly where the tubular sections to be joined or the casings have been deformed out of the circular cross-section, for example as a result of damage during the transport or storage, or are otherwise out of round, and thus are non-concentric. Further, the quality of the connection between the material of the casing member and the material of the outer surface of the tubular section may not reach such standards as may be considered desirable in some circumstances, with gaps in the fusion bonding of the casing and the polymeric outer surface of the pipe.

U.S. Pat. No. 4,866,252 (Van Loo et al) published Sep. 12, 1989, and incorporated herein by reference, discloses a connection between preinsulated pipes having a casing and sleeve articles, one disposed over each end of the casing where it overlaps the jacket of the preinsulated pipe. The articles have a bonding material that will form a fusion bond to the jacket, an outer heat shrink layer and a built in electrical heating element in contact with the heat shrink layer for heating and shrinking the outer layer. Since the heat flux from the built-in heating element is relatively small, the heat shrink layers are made thin to permit heat penetration and shrinking of the heat shrink layer, and according to the patent the thickness of the article before heat shrinking may be up to 6 mm. The article is less useful where thicker casing members are desired for use with large diameter preinsulated pipes.

Our Canadian patent application 2,704,406, incorporated herein by reference, describes a casing member for forming a connection between two tubular sections; the casing member has, at each side, a side portion comprising a cross-linked polymer material, and a second layer of non-crosslinked second layer. The cross-linked polymer layer is heat-shrinkable to provide hoop stress; the non-cross linked polymer layer is fusion bonded to the polymeric outer surface of the pipe using a heating element, such as an electrically resistant wire mesh, for example, copper wire, incorporated within the casing member or placed between the casing member and the polymeric outer surface of the pipe. The heating element is connected to a power supply, and converts the electrical energy provided by that power supply to heat, melting and fusing the casing to the polymeric outer surface of the pipe.

As would be appreciated to a person of skill in the art, a fusion bond is created when two compatible plastics materials melt and fuse together under fusion or welding conditions. A fusion bond results in a continuously homogeneously weld portion or a near-homogenously weld portion. The hoop stress facilitates formation of the fusion bond. This fusion bond is typically of much greater quality than a bond created when a heated adhesive material is used. In an adhesive bond, the substrate to which the adhesive material is applied does not necessarily melt, and after cooling, a distinct interface remains between the adhesive material and the substrate.

Though the method described in 2,704,406 works well, it has certain disadvantages. First, the method, as described, has at least two layers of polymer in the casing member—one non-crosslinked for fusion bonding to the outer polymeric jacket of the pipe, which is, itself, almost exclusively non-crosslinked; a second, cross-linked layer to provide strength, rigidity, and hoop stress. We have also found that, though the method works well in the field, in the case of electrically heatable casings, having an electric heating element within the casing member requires wires, terminals, or some other electric connection between the casing member and an external electric source; these wires or terminals can break off or become entangled in the harsh field conditions pipelines are often installed under. Even more common is that the connecting wire is accidentally burned and/or destroyed during the heat shrinking stage, which occurs before the fusion bonding. Thus, complex and costly protection methods have to be undertaken to protect the connecting wire, which leads to higher costs and an increase in the complexity of (and the time required for) installation in the field. Finally, if a connecting wire, or the wire comprising the electric heating element, is damaged, but visibly looks intact, a suboptimal fusion may occur without the user/operator realizing it. Thus, a fusion process might be undertaken, thinking that an effective fusion has taken place, but in reality no fusion, or a poor fusion, may have occurred due to the damaged wire. This is problematic, since one may not realize the presence of a poor weld until months or years later, when water penetrates the joint and pipeline failure occurs.

U.S. Pat. No. 4,629,216, incorporated herein by reference, describe a non crosslinked non-shrinkable casing welded to the jacket by means of resistant wire elements. This suffers from the problems described above in terms of loose wires getting entangled or damaged, as well as the problems of non-concenticity between the casing and pipe jacket leaving poor welded areas, or even voids.

U.S. Pat. No. 4,990,380, incorporated herein by reference, describes crosslinked heat shrinkable casing welded to the jacket by means of resistant wire elements or a conductive fillers in the casing. This suffers from the problems described above in terms of loose wires getting entangled or damaged; however it does overcome the problems of non-concentricity between the casing and pipe jacket that could leave poor welded areas and voids.

Use of electric heating elements for binding casings is also described in the Mounting Instructions for the Electric Welder for BemaFlex Welding Joints (BemaFlex, Farso, Denmark). The BemaFlex casing system comprises a welding band which is a heating element, fitted to the outer surface jacket of the pipe on each end of the pipe joint. A casing is then slid over the pipe joint, and the ends of the casing are heat shrunk to the outer surface jackets on each end of the pipe joint. Once the casing has cooled, buckles are placed around the heat shrunk sections, and current is applied to the welding band, through electrical connections connected to the welding band and extending beyond the casing, between the casing and the outer surface jacket. The application of electric current causes the welding band to heat, which melts and fuses the casing to the outer surface jacket. The casing is then drilled, foam insulation is injected into the drill holes to fill the gap between the casing and the exposed pipe joint, and the drill holes are capped. This system also suffers from the problems described above in terms of loose wires getting entangled or damaged, however it does overcome the immediate problems of non-concentricity between the casing and pipe jacket that could leave poor welded areas and voids, as the hoop stress during shrinking would affect intimate contact between the casing, the electric element and the jacket surface. The presence of the weld between the casing and jacket maintains the seal for the long term despite potential stress-relaxation of the non-crosslinked casing and the loss of hoop stress.

Belmaflex also promotes a non-crosslinked heat-shrinkable casing that is bonded to the jacket with an adhesive. While this does not have the problems described above in terms of loose wires etc, it does overcome the immediate problems of non-concentricity between the casing and pipe jacket. In addition, this system has the absence of the weld between the casing and jacket, and the joint relies solely on the adhesive to maintain the seal. The non-crosslinked casing will over time undergo stress-relaxation and suffer from the loss of hoop stress, and thereby loose the seal at the adhesive interface.

We have discovered that application of inductive heating to a non-crosslinked heat-shrinkable casing provides substantial advantages over the known systems described above.

### BRIEF DESCRIPTION OF FIGURES

FIGS. 1-8 show, somewhat schematically, longitudinal cross-sections through the tubular casing members in accordance with various embodiments of the present invention.

FIG. 9 shows an induction coil apparatus used in the method of certain embodiments of the invention.

FIG. 10 shows various casing designs in accordance with various embodiments of the present invention.

### DETAILED DESCRIPTION

The present invention provides a method for casing installation on a pipe joint utilizing a non-crosslinked, shrinkable casing. While not providing as strong and long term hoop stress as a cross-linked counterpart, a non-crosslinked shrinkable casing is significantly less expensive to produce. In one embodiment, the non-crosslinked shrinkable casing is a one-layer casing, providing further cost advantage over the prior art methods.

The one-layer casing is adapted to be heat-shrunk with an external heat source and as such may be of substantial thickness. In the preferred form, the casing thickness before heat shrinking may be about 2 to 25 mm, more typically 2 to 15 mm. It is an advantage of the preferred structure that for use with large diameter tubular sections, for example, greater than 560 mm diameter, said casing thickness may be 8 to 25 mm.

In one embodiment, the non-crosslinked casing is fitted around the circumference of the pipe around the joint, so that it overlaps the polymeric outer surface jacket of the pipe at either end of the joint cavity; heat is applied to shrink the casing, providing hoop stress between the casing and the polymeric outer surface jacket; and the casing is fused to the polymeric outer surface jacket via the electromagnetically sensitive medium using induction energy provided by an induction coil applied around the casing. The method utilises an electromagnetically activatable layer between or within the casing or the polymeric outer surface jacket, proximal to the interface between the casing and the polymeric outer surface jacket. The electromagnetically activatable layer acts as an element, which is heated by the induction coil, to a temperature greater than the melting point of both the polymeric outer surface jacket and the non-crosslinked polymeric substance that forms the casing. This in turn causes melting of the two surfaces, which are compressed together due to the hoop stress provided by the shrinking of the casing around the polymeric outer surface jacket. Note that, unlike a cross-linked polymeric casing, the heat shrinking of the non-crosslinked casing will have time-limited sustained hoop stress over the polymeric outer surface jacket; this hoop stress creates intermingling of the molecules of the two molten surfaces, resulting in the fusion of the casing to the polymeric outer surface jacket. The fact that the casing is non-cross linked or has a very low crosslink level (less than 35%, preferably less than 15%) allows relatively free molecular movement during the melting phase to facilitate the fusion. Although the hoop stress is less permanent, and less strong, than the hoop stress that would have been provided with a cross-linked material, it is sufficiently strong, for a sufficient duration of time, to aid in the fusion of the two molten surfaces. It is noted that the induction coil does not necessarily need to make any contact with the casing or the pipe outer surface jacket nor is any wire connection required between the induction coil and the inductive element. This is a big advantage in the rough field conditions where the inclement weather, such as snow, rain and sand-storms may be present.

The casing may be in the form of a pre-formed cylindrical casing, which is applied to the pipeline before the two sections of pipe are welded together, then is placed in position such that the two ends of the casing overlap the polymeric outer surface jacket of the pipe on either end of the pipe weld joint. Alternatively, the casing may be in the form of a sheet, which is wrapped around the circumference of the weld joint, overlapping the polymeric outer surface jacket of the pipe on either end of the weld joint, and having two edges extending longitudinally between the two pipe sections, said edges being connected together, for example, using a field welding machine to form a casing.

The electromagnetically activatable layer, also referred to herein as an inductive element, can be any electromagnetically sensitive medium between the casing and the polymeric outer surface jacket, or can be incorporated within the casing and/or the polymeric outer surface jacket. For example, the inductive element can be a polymeric film which is filled with metallic or magnetic fillers that are responsive to eddy currents from induction heating coils, such as an Emabond(R) filled-tape available from Emabond Solutions of Norwood, New Jersey, USA and described in U.S. Pat. No. 3,620,875, incorporated herein by reference. The Emabond filled-tape is either placed between the casing and the polymeric outer surface jacket, or is incorporated within the non-crosslinked material that forms the casing, either at the side portions of the casing, or throughout the casing. Alternatively, the filled-tape can be incorporated within the end portions of the pipe outer surface jacket, or throughout the pipe outer surface jacket.

The term “non-crosslinked polymer”, as it is used herein, means a polymer that would be considered by a person knowledgeable in the art to be generally non-crosslinked in structure. This would include polymeric materials having no crosslinking at all within their structure, but would also be readily understood to mean a polymeric material having no significant amount of crosslinking within its structure, for example, a material with a very low crosslinking level, with less than 35%, preferably less than 15%, of the polymer being crosslinked.

The polymer can be any polymer typically used to coat pipes, or any polymer fusible to a polymer typically used to coat pipes. In certain embodiments, the polymer is a polyolefin such as polyethylene, though a wide variety of other polymers may be used.

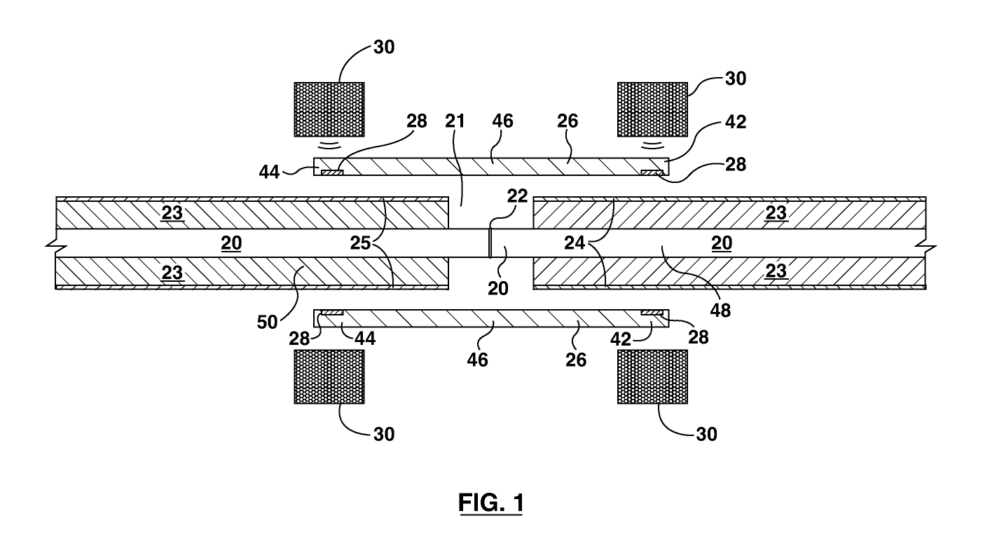

FIG. 1 shows, somewhat schematically, a longitudinal cross-section through the tubular casing members in accordance with one form of the present invention. Shown is an insulated pipe junction. A tubular casing member in the form of pipe 20 having a girth weld 22, a foam insulation layer 23, and an outer surface jacket 24, 25 is shown. The outer surface jacket 24, 25 is a polymeric material, for example, a polyolefin such as polyethylene which forms the outer surface jacket 20, over the foam insulation 23 which in turn covers the pipe 20. When two sections of pipe are welded together in the field, the bare ends of pipe 20 are exposed, to form the girth weld 22, with the remainder of the pipe covered by foam insulation 23 with an outer surface jacket 24 and 25. Shown is shrinkable casing 26, which has two side portions 42, 44 and a middle portion 46 spanning between said side portions. The side portions 42, 44, when fitted, overlap with end portions 48, 50 of outer surface jacket 24, 25, respectively. Middle portion 46 spans the exposed pipe 20 and girth weld 22. The casing 26 is made primarily from a non-crosslinked polymeric material, such as polyethylene. Incorporated within each of side portions 42, 44 of casing 26 are an induction element 28. As shown, the induction element 28 is a wire mesh encapsulated within the polyethylene material of the casing 26, extending around the diameter of the casing 26, said wire mesh being sensitive to induction currents. The wire mesh is configured so that it is able to shrink, recover or compress when the casing 26 is shrunk around the outer surface jacket 24, 25. However, the induction element 28 may also be in the form of a filled film or magnetic particles incorporated within the casing 26 and extending around the diameter of same.

Induction element 28 may be in the form of a filled polymeric tape, such as Emabond(R) filled-tape. When such a filled-tape is rendered heat shrinkable, it tends conform readily to the pipe jacket substrate. This is especially advantageous when the tape is attached to the inside of the casing surface. When the casing shrinks to the smaller diameter, if the filled tape is not shrinkable, then it will be susceptible to folding and distorting, which may be less desirable. The means of making a tape heat recoverable, or shrinkable, is commonly know to those skilled in art. This involves applying a controlled stretching or orientation to the tape under heat and then cooling it while in the stretched state. Thus the induction element 28 may be in the form of a heat shrinkable filled polymeric tape.

To form a connection between the tubular sections represented by outer surface jackets 24, 25, the casing 26 is fitted as shown. The casing 26 is then heat shrunk, creating hoop stress between side portions 42, 44 and end portions 48, 50, respectively. Then an induction heating coil 30 is used to provide inductive energy, activating and heating induction element 28. Due in part to the hoop stress, the heating of induction element 28 causes melting of side portions 42,44 and end portions 48,50, resulting in a fusing of side portion 42 to end portion 48, and side portion 44 to end portion 50. Over time, the hoop stress may relax, but the fusion holds and creates a lasting connection between the tubular sections. After a connection is formed, all the layers (i.e. casing 26 and outer surface jacket 24, 25) are fused together, so that the boundaries between the layers are not visible to the naked eye.

Heat shrinking can be performed using any method known in the art. For example, heat shrinking can be performed using a flame torch, applied to the casing 26 by an operator; it can also be performed using a specialized apparatus such as the apparatus described in PCT patent application PCT/CA2010/000334. In preferred form, a heat source external to the casing 26, such as a conventional heating torch, heating blanket, or infrared heater, is applied to the exterior surface of the casing by an operator, to cause the sides of the casing 26 to shrink down tightly on the underlying overlapped portions (end portions 48, 50) of the outer surface jacket 24, 25. The shrunk down sections conform closely to the profile of the outer surface jacket 24, 25, eliminating any gapping that might, in the case of a non-shrinkable structure, result in non-concentricity between the casing 26 and the outer surface jacket 24, 25. The heat shrinking is primarily or exclusively in the circumferential direction, with little or no longitudinal shrinking taking place.

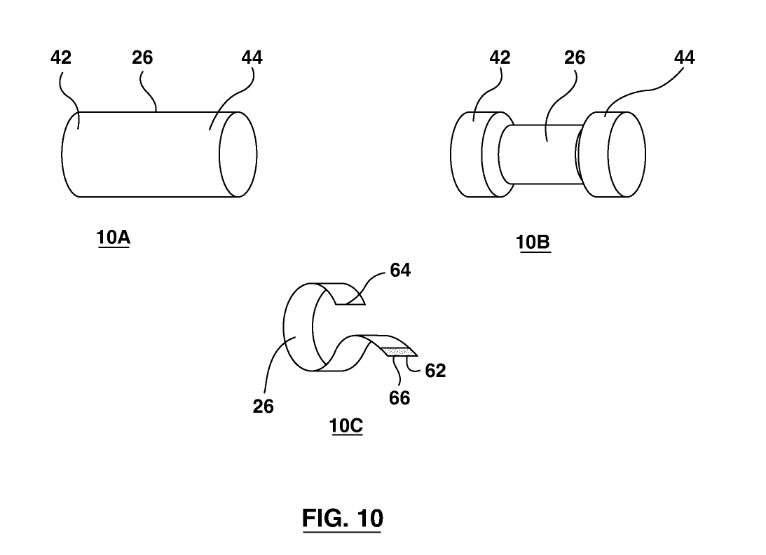

The induction heating coil 30 can be any apparatus able to provide induction energy to induction element 28. In one embodiment, the induction heating coil 30 is housed within a rigid frame capable of surrounding or enclosing the casing 26, to provide energy through an entire circumference of a portion of the casing 26. The rigid frame may have a hinge element in order to place and remove the rigid frame around the casing 26. In another embodiment, the induction heating coil 30 can be housed within a blanket or other flexible housing, which can be applied directly to the casing 26 by an operator. Typically, the induction heating coil 30 is connected to an external source of electrical energy. Certain embodiments of induction heating coil 30 are further elucidated in FIG. 10, below.

After the casing 26 has been heat shrunk, and induction fused to the outer surface jacket 24, 25, the gap 21 proximal to the exposed pipe 20, which contains no foam insulation layer, may be filled with foam insulation. This can be done, for example, by drilling a hole in the casing 26 and filling it with a suitable foam precursor. The hole can then be filled or plugged.

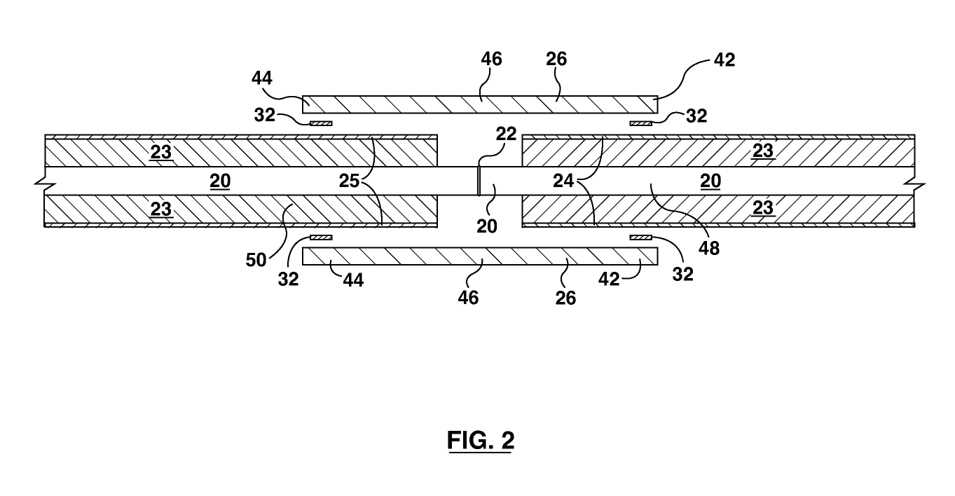

FIG. 2 shows an alternative embodiment of the invention. Similarly to FIG. 1, FIG. 2 shows, somewhat schematically, a longitudinal cross-section through the tubular casing members in accordance with one form of the present invention. Pipe 20 having a girth weld 22, a foam insulation layer 23, and an outer surface jacket 24, 25 is shown. Heat-shrinkable casing 26 is also shown. However, there is no induction element incorporated within each of side portions 42, 44 of casing 26. Instead, a separate, inductive element 32 is placed between outer surface jacket 24, 25 end portions 48, 50 and side portions 42, 44 of casing 26. In this manner, a “standard”, non-crosslinked casing 26 can be used. Once the inductive element 32 and casing 26 are fitted around outer surface jackets 24, 25, side portions 42, 44 are fused to end portions 48, 50 as described for FIG. 1.

Alternatively, instead of an inductive element 32 as shown, a polymeric film which is filled with metallic or magnetic fillers can be applied, either to the surface of the end portions 48, 50 or side portions 42, 44, resulting in a similar effect.

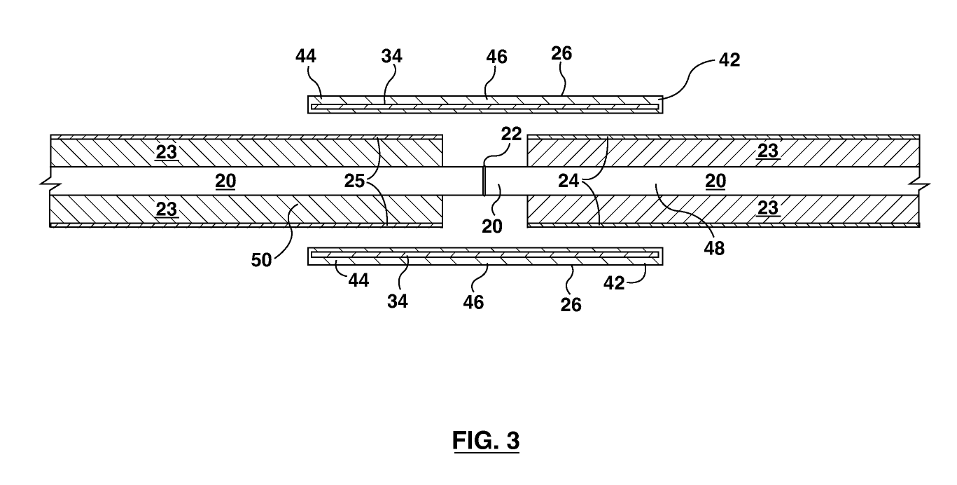

FIG. 3 shows an alternative embodiment of the invention. Similarly to FIGS. 1 and 2, FIG. 3 shows, somewhat schematically, a longitudinal cross-section through the tubular casing members in accordance with one form of the present invention. Pipe 20 having a girth weld 22 and an outer surface jacket 24, 25 is shown. Heat-shrinkable casing 26 is also shown. However, instead of being only present at side portions 42, 44, the induction element is present in the form of inductive layer 34, which extends the entire surface of the casing. In this manner, for example, the casing 26 can be manufactured as a simple, uniform structure, having within it, an induction element. Inductive layer 34 can be a layer of inductive wire mesh, or, for example, an applied film of magnetic material.

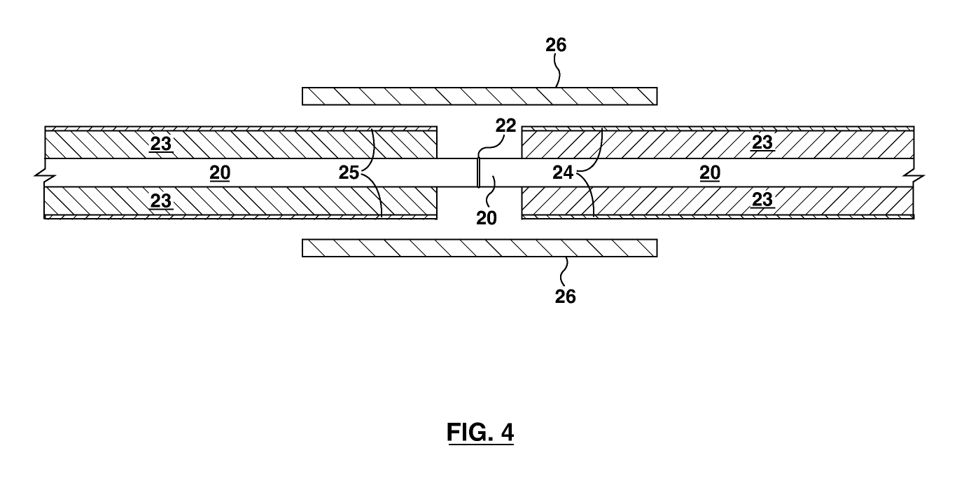

FIG. 4 shows a further alternative embodiment of the invention. Similarly to FIGS. 1-3, FIG. 4 shows, somewhat schematically, a longitudinal cross-section through the tubular casing members in accordance with one form of the present invention. Pipe 20 having a girth weld 22, a foam insulation layer 23, and an outer surface jacket 24, 25 is shown. Heat-shrinkable casing 26 is also shown. However, instead of being only present at side portions 42, 44, or present as a separate layer within the casing 26, the entire casing 26 has inductive properties, by means of inductive elements interspersed within it. This may be in the form of an interspersing of a filled film, magnetically susceptible particles, or conductive particles (e.g.steel, iron, nickel, iron oxide,carbon) incorporated at random or at defined intervals within the casing. For example, a casing can be formed using an extrusion process, incorporating, within the polyethylene being extruded, an amount of Emabond(R) Tape. Thus, the entire casing would contain some amount of Emabond(R) Tape, and thus, some amount of inductive material. The entire casing would thus heat up when subjected to induction energy, for example, through the wrapping of an induction coil around the casing.

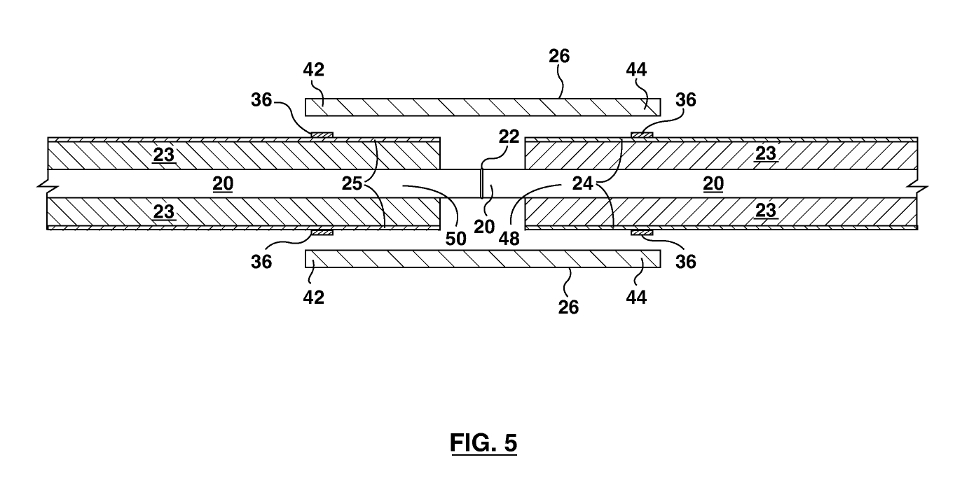

FIG. 5 shows a further alternative embodiment of the invention. Similarly to FIGS. 1-4, FIG. 5 shows, somewhat schematically, a longitudinal cross-section through the tubular casing members in accordance with one form of the present invention. Pipe 20 having a girth weld 22, a foam insulation layer 23, and an outer surface jacket 24, 25 is shown. Heat-shrinkable casing 26 is also shown. However, in this embodiment, the induction element is in the form of inductive element layer 36, which, as shown, is an inductive wire mesh or filled tape wrapped around end portions 48, 50 of pipe. As would be understood by a person of skill in the art, the embodiment shown in FIG. 5 has the added advantage that the inductive element does not gain any advantage if it is configured to allow for shrinking. Thus, for forming the connection, the casing 26 is shrunk around pipe ends 24, 25, then an inductive coil (not shown) provides inductive energy to inductive element layer 36, melting and fusing the non-crosslinked casing to the pipe outer surface jacket 24, 25 proximal to it. Hoop stress between outer surface jacket 24, 25 and casing 26 help fuse side portions 42, 44 to end portions 50, 48.

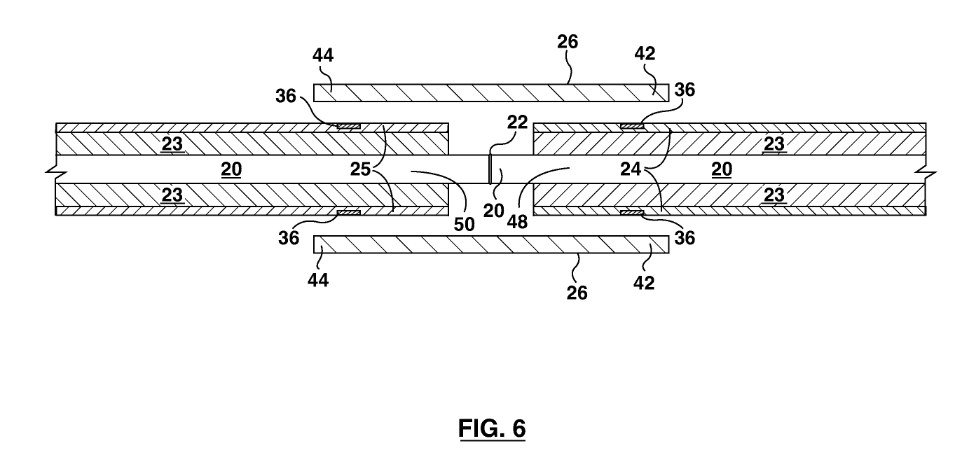

Instead of being applied to the pipe, pipe inductive layer 36 may be incorporated within the outer surface jacket 24, 25 of the pipe 20 as shown in FIG. 6.

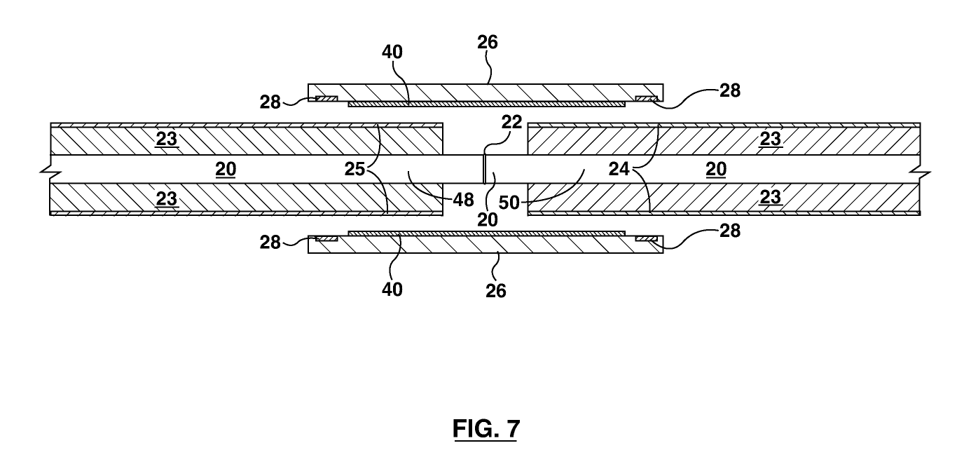

FIG. 7 shows a further alternative embodiment of the invention. Here, casing 26 is fused to end portions 48, 50 at side portions 42, 44 respectively, through the application of inductive energy from an induction coil (not shown) to induction element 28. However, casing 26 is also adhesively bound to the pipe outer surface jacket 24, 25 through adhesive layer 40. This provides a standard adhesive layer bond for the majority of the length of the casing, with fused “caps” at either end, providing the advantages of both bonding and fusing.

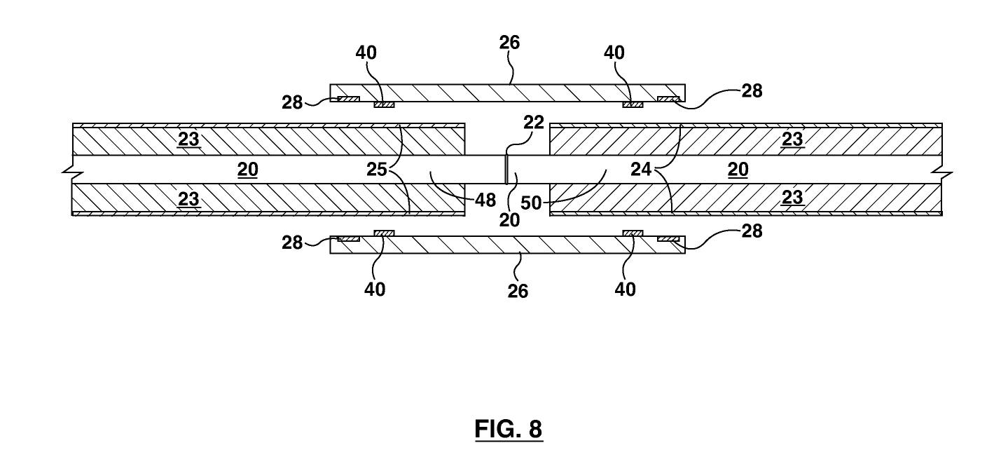

FIG. 8 shows a further alternative embodiment, similar to that shown in FIG. 7. However, here, the adhesive layer is placed adjacent to the inductive element 28, 21, on the side closer to the pipe weld 22. This provides the benefit of strong weld bond so that the casing is mechanically anchored to the pipe jacket in order to resist pipe movement and soil stresses, while the adjacent adhesive layer provides a further seal against water ingress. The adhesive layer can be, for example, between 1-15 cm in width.

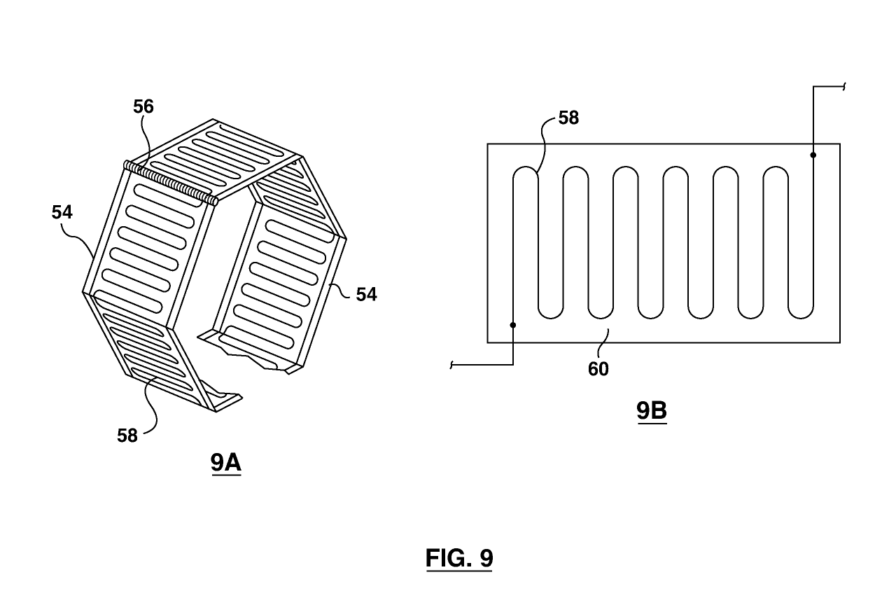

FIGS. 9A and 9B show two exemplifications of induction coil 30. In FIG. 9A, induction coil 30 comprises a frame 54 having a hinge region 56. The frame 54 can be opened through rotation at hinge region 56, placed around a casing (not shown), then closed. The frame 54 houses a coil 58 capable of providing induction energy. Note that the figures are largely schematically drawn: the direction of the coil is only for illustrative purpose; the coil direction can also be in the circumferential direction. Coil 58 is connected to an electrical power source (not shown). The frame 54 and coil 58 are configured such that, when the frame 54 surrounds casing (not shown), coil 58 is capable of providing induction energy to the entire circumference of casing. FIG. 9B shows a different induction coil 30, wherein coil 58 is attached to, or housed within a flexible blanket 60. The blanket 60 is made of a material that is flexible, and can withstand significant heat, for example, silicone. In use, the blanket 60 can surround casing (not shown), and thereby coil 58 can provide induction energy to the entire circumference of casing. Again, the direction of the coil is only for illustrative purpose; it can also be in the circumferential direction.

FIGS. 10 A, B and C show three exemplifications of casing 26. In FIGS. 10A and 10B, casing 26 is a pre-formed cylindrical casing, which is applied to the pipe joint before the two sections of pipe are welded together, then is placed in position such that the two ends 42, 44 of the casing overlap the polymeric outer surface jacket of the pipe on either end of the pipe weld joint (not shown). In FIG. 10B, the pre-formed cylinder is formed such that the middle of the cylinder is tapered. This allows for better fit around the girth weld, in certain circumstances. In FIG. 10C, the casing 26 is in the form of a sheet, which can be wrapped around the circumference of the weld joint, overlapping the polymeric outer surface jacket of the pipe on either end of the weld joint, and having two edges 64, 66 extending longitudinally between the two pipe sections, said edges being connected together by welding or bonding to form a casing.

### PARTS LIST

20 pipe

21 gap

22 girth weld

23 foam insulation layer

24 pipe outer surface jacket

25 pipe outer surface jacket

26 casing

28 induction element

30 induction coil

32 inductive element

34 inductive layer

36 inductive element layer

38 cross-linked layer

40 adhesive layer

42 side portion

44 side portion

46 middle portion

48 end portion

50 end portion

52 non-cross linked layer

54 frame

56 hinge region

58 coil

60 flexible blanket

62 adhesive strip

1. A method for forming a connection between two tubular insulated pipe sections each having a polymeric outer surface jacket, comprising:
fitting a casing member around the circumference of the two tubular sections;
said casing member having at each side a side portion for connecting on a respective adjacent end portion of each of the outer surface jackets of the tubular sections, and a middle portion that spans between the side portions and, when fitted, spans between the two end portions;
said casing member being heat shrinkable in the direction of the circumference of the adjacent tubular sections;
said side portions made from a non-crosslinked polymeric material capable of fusion bonding to the end portions of the outer surface jackets;
said side portions, end portions, and/or a fitting placed between said side portions and said end portions having an inductive element;
heat shrinking said casing member to provide hoop stress between said casing member and the two tubular sections;
fusing the side portions to the end portions by applying inductive energy to the inductive element.

2. The method of claim 1 wherein the polymeric outer surface jacket is a non-crosslinked material.

3. The method of claim 1 wherein the casing member is made from a non-crosslinked polymeric material.

4. The method of claim 1 wherein the casing member is a heat-shrinkable casing, which is placed around the circumference of the two tubular sections.

5. The method of claim 1 wherein the casing member is a sheet which is wrapped around the circumference of the two tubular sections and having two edges which are connected together to form a casing.

6-7. (canceled)

8. The method claim 1 wherein the inductive element is a perforated metal strip.

9-10. (canceled)

11. The method of claim 1 wherein the inductive element comprises a polymeric tape or film filled with a plurality of magnetically susceptible particles or conductive particles, whereby the polymeric tape or film is capable of welding to the casing and pipe jacket.

12-15. (canceled)

16. The method of claim 1 wherein the inductive element is rendered heat shrinkable, or capable of reducing in length longitudinally.

17. (canceled)

18. The method of claim 1 wherein the inductive energy is applied by an inductive coil circumferentially disposed around said casing areas under which inductive elements are disposed.

19. A casing member for forming a connection between two tubular sections, the casing member having at each side a side portion for connecting on a respective adjacent end portion of each of the outer surface jackets of the tubular sections, and a middle portion that spans between the side portions and, when fitted, spans between the two end portions; said casing member being heat shrinkable in the direction of the circumference of the adjacent tubular sections; said side portions made from a non-crosslinked polymeric material capable of fusion bonding to the end portions of the outer surface jackets; and said side portions having an inductive element incorporated within or disposed around an inner surface.

20. The casing member of claim 19 wherein the entire casing member is made from a heat shrinkable, non-crosslinked polymeric material.

21. The casing member of claim 19 in the form of a pre-formed casing, capable of being placed around the circumference of the tubular sections.

22. The casing member of claim 19 in the form of a sheet, capable of being wrapped around the circumference of the two tubular sections and having two edges which are capable of being connected together to form a casing.

23-24. (canceled)

25. The casing member of claim 19 wherein the inductive element is a plurality of magnetic particles incorporated within the side portions of the casing member.

26. The casing member of claim 19 wherein the inductive element is a plurality of magnetic particles incorporated throughout the casing member.

27. (canceled)

28. The casing member of claim 19 wherein the inductive element is a metal mesh or netting incorporated within the side portions of the casing member.

29. The casing member of claim 19 wherein the inductive element is a perforated metal strip incorporated within the side portions of the casing member.

30. (canceled)

31. The casing member of claim 19 wherein the inductive element comprises a polymeric encapsulation that is capable of welding to the casing and pipe jacket.

32. The casing member of claim 19 wherein the inductive element comprises a polymeric tape or film filled with a plurality of magnetically susceptible particles or conductive particles, whereby the polymeric tape or film is capable of welding to the casing and pipe jacket.

33. The casing member of claim 32 wherein the inductive element is heat shrinkable, or capable of reducing in length longitudinally upon application of heat.

34-38. (canceled)
